(19) United States
(12) Patent Application Publication
(10) Pub. No.: US 2014/0061343 A1
(43) Pub. Date: Mar. 6, 2014

(54) GRATING APPARATUS

(71) Applicant: MAXPAT TRADING AND MARKETING (FAR EAST) LTD., Kowloon (HK)

(72) Inventor: Patrick WAIBEL, Kowloon (HK)

(73) Assignee: MAXPAT TRADING AND MARKETING (FAR EAST) LTD., Kowloon (HK)

(21) Appl. No.: 14/012,075

(22) Filed: Aug. 28, 2013

(30) Foreign Application Priority Data
Aug. 29, 2012 (GB) 1215358.1

(51) Int. Cl. A47J 43/25

(52) U.S. Cl. CPC A47J 43/25
USPC 241/95; 241/273.1

(57) ABSTRACT

The present invention is concerned with a grating apparatus. The apparatus has a grating member provided with a grating surface configured to interact with a food item. The grating member includes a plurality of assemblies of teeth pointing away from the grating surface, wherein the assemblies of teeth include pointed teeth of non-homogenous in size, each pointed tooth has a body defining at least a first triangular side with an angle of inclination from substantially 44-67° with respect to the grating surface.

### FIELD OF THE INVENTION

The present invention is concerned with a kitchen utensil and more particularly but not limited to a grating apparatus.

### BACKGROUND OF THE INVENTION

There are a variety of conventional kitchen tools or appliances for grinding or grating foodstuff. Some of these conventional tools are electrically operated and are able to grate foodstuff efficiently by making use of motorized grating members. However, electric food graters are relatively costly and a cost-conscious household usually would not carry such a grater. Further, there is a perception that fresh foods such as fresh vegetables tend to lose their natural favors or texture after having been machine-grated. In other words, manual grating is still preferred over machine grating when quality grating is needed.

There are also a variety of manual graters or vegetable graters in the market for grating different foodstuffs. While most of these graters are relatively simple in construction and useful to a certain extent, they often suffer from different problems. For example, some manual graters cannot grate foodstuff efficiently and a user would need to forcefully press a foodstuff against the grater and move the foodstuff reciprocatingly and quickly back and forth for a prolonged period of time before grated foodstuff can be generated. A user with weaker palms would not be able to perform this task. Another common problem is that some conventional manual graters often generate grated foodstuff but the grated foodstuff would tend to lose its juice during the grating process. Yet another problem is that some manual graters often cannot grind the foodstuff sufficiently fine, especially when the foodstuff tends to be fibrous (e.g. radish, ginger, etc.)—in that case the grated foodstuff would still retain the un-grated fibers of the foodstuff. This is not acceptable to those with a high expectation on culinary art.

The present invention seeks to address at least some of the aforementioned problems, or to provide the public with an alternative.

### SUMMARY OF THE INVENTION

A grating apparatus comprising a grating member provided with a grating surface configured to interact with a food item, the grating member including a plurality of assemblies of teeth pointing away from the grating surface, wherein a) the assemblies of teeth include pointed teeth, b) at least some of the pointed teeth have a vertex and a body defining at least a first triangular surface with an angle of inclination from substantially 44-67° with respect to the grating surface, c) the grating member is substantially made of an injection moldable plastic(s), and wherein the body is pyramidal in shape and defines a second triangular surface generally symmetric to the first triangular surface, d) the pyramidal bodies are non-homogenous in size, e) the pyramidal body defines a third triangular surface, the third triangular surface is generally perpendicularly extended from the grating surface, and f) the pyramidal body is made of relatively hard injection moldable plastic(s) for food grinding. Results have shown that this particular combination of features are advantageous in achieving sufficiently fine grating, including grating of fibrous foodstuff such as ginger, etc., and yet grating can be achieved efficiently in relatively fine reciprocating movement against the foodstuff. Different in size of the bodies can create a greater degree of unevenness and thus can facilitate the grating process.

Preferably, the pointed teeth may have a height of substantially 0.83-1.68 mm or preferably 0.93-1.53 mm, a width of substantially 1.35-1.74 mm or preferably 1.50-1.59 mm and/or a length of substantially 1.57-2.1 mm or preferably 1.75-1.91 mm.

In an embodiment, the density of the pointed teeth on the grating surface may be 3-5 pointed teeth/cm², or preferably 4 pointed teeth/cm².

In one embodiment, each of the assemblies of pointed teeth may be arranged around a predetermined boundary, the predetermined boundary may be in the shape of a rectangle, a circle, an oval or the English letter “L”. The grating member may preferably be provided with cut-out regions at the predetermined boundary whereby in use grated foodstuff can pass through the cut-out regions. The grating apparatus may comprise a container for containing grated foodstuff and on which the grating member can fit. The container may be sized and shaped to fit the grip of one palm of a user during a grating exercise such that in use the user can tightly hold on to the grater use by the palm and grate a food item against the grating member with the other palm.

In a specific embodiment, each of the pointed teeth may generally define a vertical axis running through the vertex of the pointed tooth, and wherein the distance between vertexes of a pair of adjacent the pointed teeth may be substantially 1.53-8.47 mm or preferably 1.70-7.70 mm.

According to a second aspect of the present invention, there is provided a grating apparatus comprising a grating member provided with a grating surface configured to interact with a food item, the grating member including a plurality of assemblies of teeth pointing away from the grating surface, wherein the teeth may include pointed teeth of non-homogenous in size, and configured to resemble a body defining at least a first triangular surface and a vertex, wherein the pointed teeth has a height, width and length of substantially 0.83-1.68 mm, 1.35-1.74 mm and 1.57-2.1 mm, respectively, and wherein the density of said pointed teeth on the grating surface is 3-5 pointed teeth/cm². In one specific embodiment, the grating member may be substantially made of an injection moldable plastic(s), and the body may be pyramidal in shape and define a second triangular surface symmetric to the first triangular surface.

The grating apparatus may be a vegetable or ginger grater.

### BRIEF DESCRIPTION OF DRAWINGS

Some embodiments of the present invention will now be explained, with reference to the accompanied drawings, in which: FIG. 1 is a schematic top view of an embodiment of a grating apparatus according to the present invention;

FIG. 2 is a side view of the grating apparatus of FIG. 1;

FIG. 3 is a perspective view of the grating apparatus of FIG. 1;

FIG. 4 corresponds to FIG. 3 but showing the grating apparatus in a different configuration;

FIG. 5 is a perspective view showing four assemblies of teeth of the grating apparatus of FIG. 1;

FIG. 6 is a top view schematically showing one of the assemblies of teeth of FIG. 5;

FIG. 7 is a side view schematically showing the grating apparatus of FIG. 1;

FIG. 8 is an enlarged view showing a portion of the grating apparatus of FIG. 7;

FIG. 9 is a perspective view of another embodiment of a grating apparatus according to the present invention;

FIG. 10 is perspective view of the grating apparatus of FIG. 9 but in a different configuration;

FIG. 11 is a top view of the grating apparatus of FIG. 9;

FIG. 12 is a side view of the grating apparatus of FIG. 9;

FIG. 13 generally corresponds to FIG. 11;

FIG. 14 and FIG. 15 are cross sectional views of the grating apparatus of FIG. 9;

FIG. 16 is a perspective view schematically showing five assemblies of teeth of the grating apparatus of FIG. 9;

FIG. 17 is a perspective view showing two adjacent teeth of the assemblies of teeth shown in FIG. 16; and

FIG. 18 is a perspective view showing one of the two adjacent teeth shown in FIG. 17.

### DETAILED DESCRIPTION OF PREFERRED EMBODIMENTS OF THE PRESENT INVENTION

The present invention is concerned with a grating apparatus. FIGS. 1 to 8 illustrate a first embodiment of the grating apparatus according to the present invention and are concerned with a grater 2. FIGS. 1-3 illustrate the grater 2 in an assembled configuration. FIG. 4 illustrates the grater 2 but in a disassembled configuration with a top member representing a grating member 4 located above a lower member. The lower member represents a container 6 in the form of a receptacle for containing grated foodstuff. The grating member 4 is configured to fit tightly above the container/receptacle 6. The grating member 4 is preferably sized and shaped to fit the grip of one palm of a user during a grating exercise such that the user can tightly hold on to the grater 2 with one palm, and grate a food item, e.g. vegetables, ginger, etc., against the grating member 4 with the other palm.

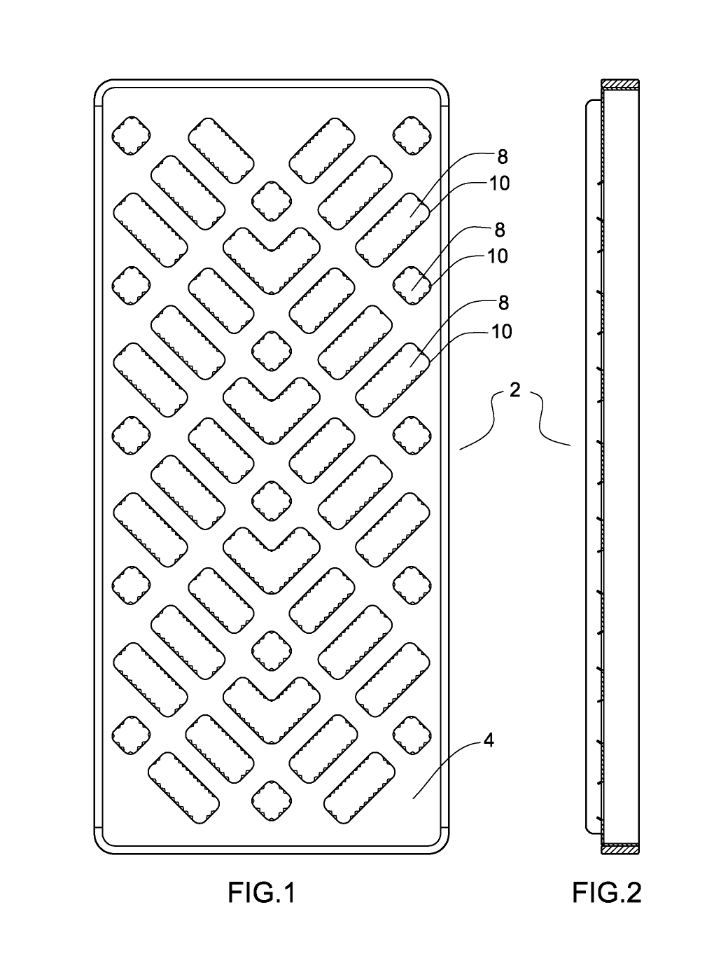

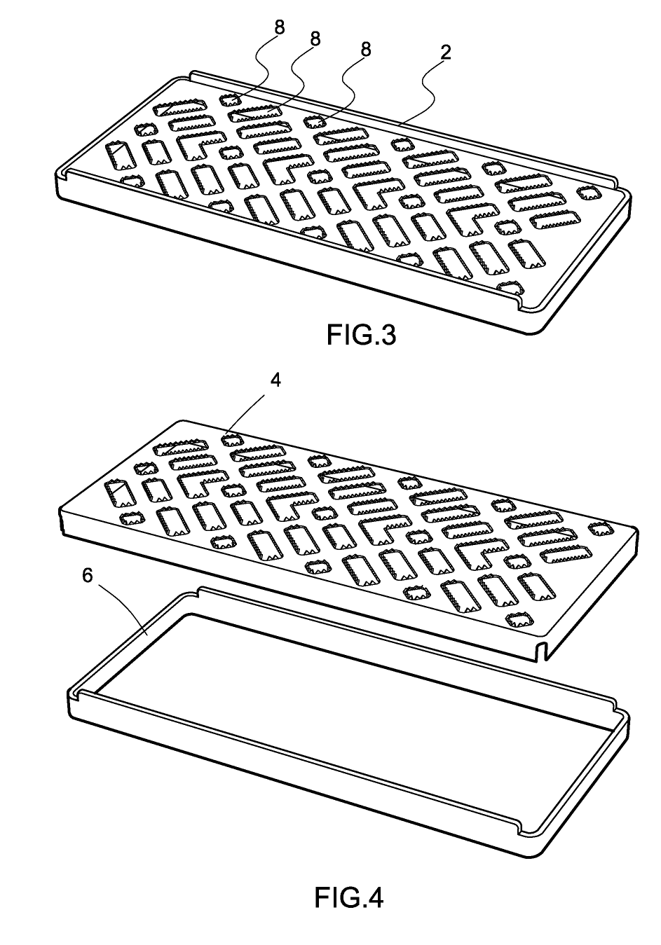

FIG. 3 is a perspective view showing the grater 2 and a plurality of assemblies 8 of teeth members extended from a generally planar grating surface of the grating member 4. The assemblies 8 of the teeth members include pointed teeth, with each assembly of the pointed teeth arranged around a predetermined boundary, as shown clearly shown in FIGS. 1-3. The boundaries 10 are sized and shaped differently although they are generally of elongate profile with round opposite ends. However, in different embodiments the boundaries may take other suitable shape such as in the shape of a rectangle, a circle, an oval or the English letter “L”. FIG. 2 is a side view of the grater 2 showing the assemblies of teeth protruding from the grating surface. It is to be understood that the pointed teeth are adapted to be relatively sharp.

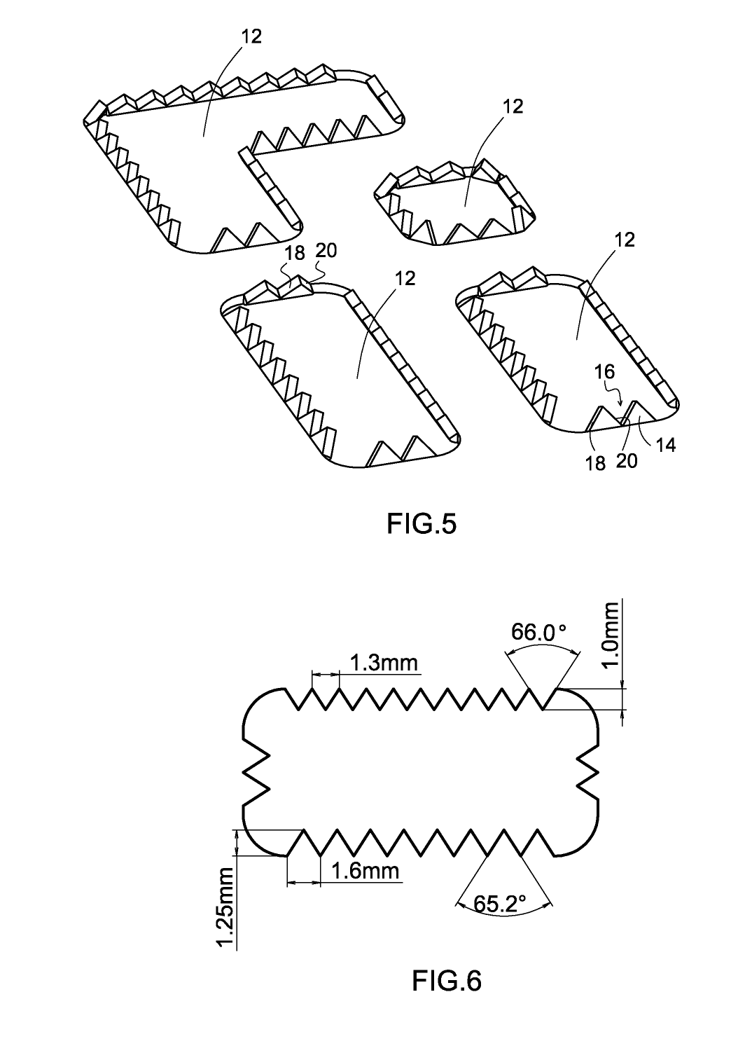

FIG. 5 exemplarily illustrates the arrangement of the assemblies of pointed teeth in greater detail. There is provided with a cut-out region 12 at each predetermined boundary such that grated foodstuff generated from a grating exercise can pass through the cut-out region 12 to the other side of the grating member 4 and received in the receptacle 6.

The pointed teeth possess a number of characteristics. Although not all these characteristics simultaneously are required to yield a better grating performance they all contribute to the better performance. One characteristic is concerned with the difference in size of the pointed teeth of the grating member and/or the pointed teeth in each assembly. Studies leading to the present invention indicate that the provision of grating teeth with non-homogenous in size may better facilitate the grating and/or produce grated foodstuff which is finer, with less fibres and/or be able to retain more juice in the grated foodstuff.

FIG. 6 illustrates the profile of an assembly of teeth in greater detail. In this embodiment, there is shown that the teeth of some of the adjacent tooth pair have different dimensions or configuration, e.g. height, length, width or spacing.

In this embodiment, the grating apparatus 2 is made of stainless steel. The grating member 24 is made by stamping on a stainless steel blank or sheet. During the stamping process, cut-out regions are produced, and pointed teeth members are formed. FIGS. 5, 7, and 8 more clearly illustrate selected assemblies of the pointed teeth. The teeth in the assemblies are generally arranged to take the form of a rectangle, a square, or resembling the English letter “L”. As shown in for example FIG. 5, each pointed tooth similarly defines a first triangular surface or side 14 although a second triangular surface or side 16 is defined and disposed on the opposite side of the stainless steel blank. The first triangular surface resembles a slope and is generally planar. Body of each pointed tooth has a thickness, the thickness being the thickness of the steel blank. The thickness of each tooth is represented by two elongate rectangular shape sides 18, 20. The teeth are different in size and different adjacent pairs of teeth are spaced differently. FIG. 6 illustrates that two adjacent teeth are spaced by substantially 1.30 mm while another two adjacent teeth are spaced by substantially 1.60 mm. FIG. 6 also illustrates that the length of one of the pointed teeth is substantially 1.00 mm and another pointed tooth is substantially 1.25 mm. FIG. 6 further illustrates that the angle between the oppositely facing sides of two adjacent pointed teeth is substantially 66°, and the angle between the oppositely sides of another two adjacent pointed teeth is 65.2°.

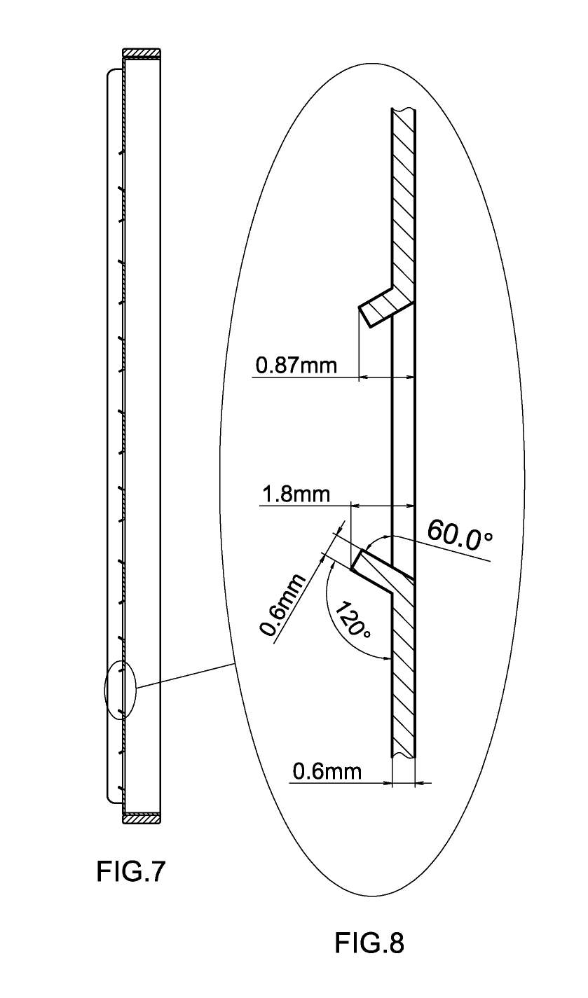

FIG. 7 schematically shows a side view of pointed teeth formed from stamping on a steel bank. FIG. 8 illustrates that the angle of inclination between the first triangular surface of the tooth and the grating surface is substantially 60° although studies have shown that an angle of inclination of substantially 44-67° or preferably 51-61° can still deliver satisfactory performance. FIG. 8 also illustrates that pointed teeth from opposite sides of a predetermined boundary are pointing towards each other.

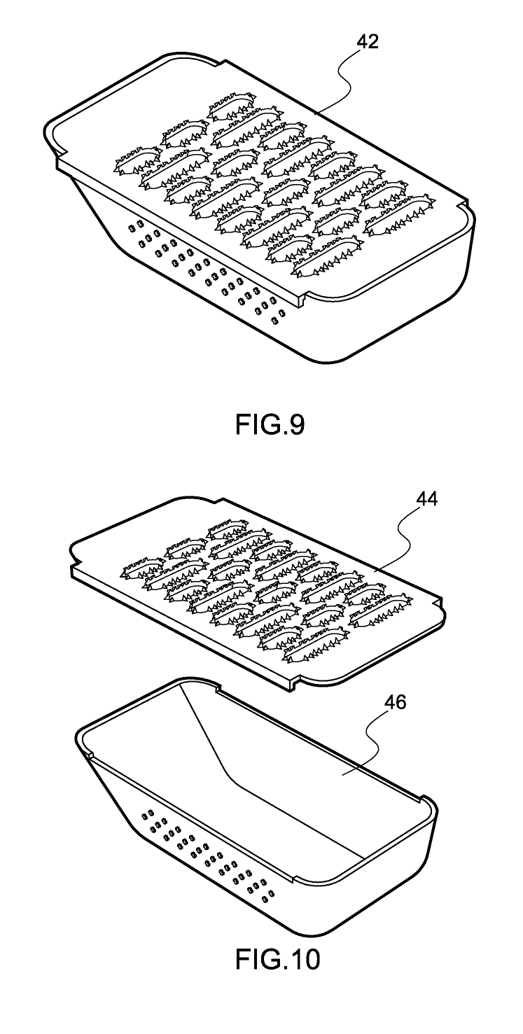

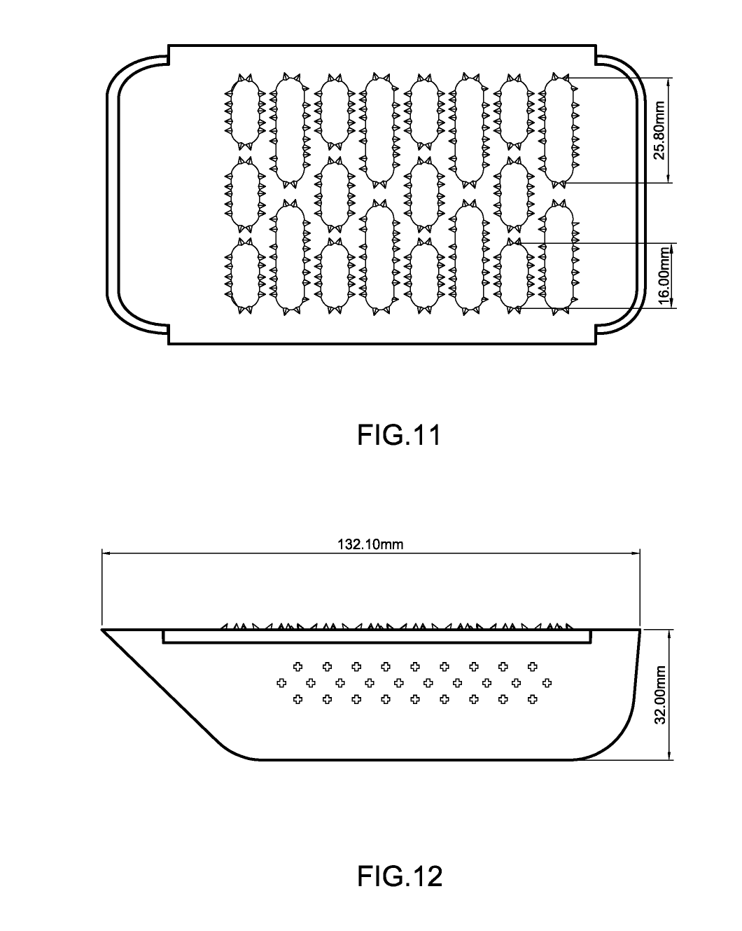

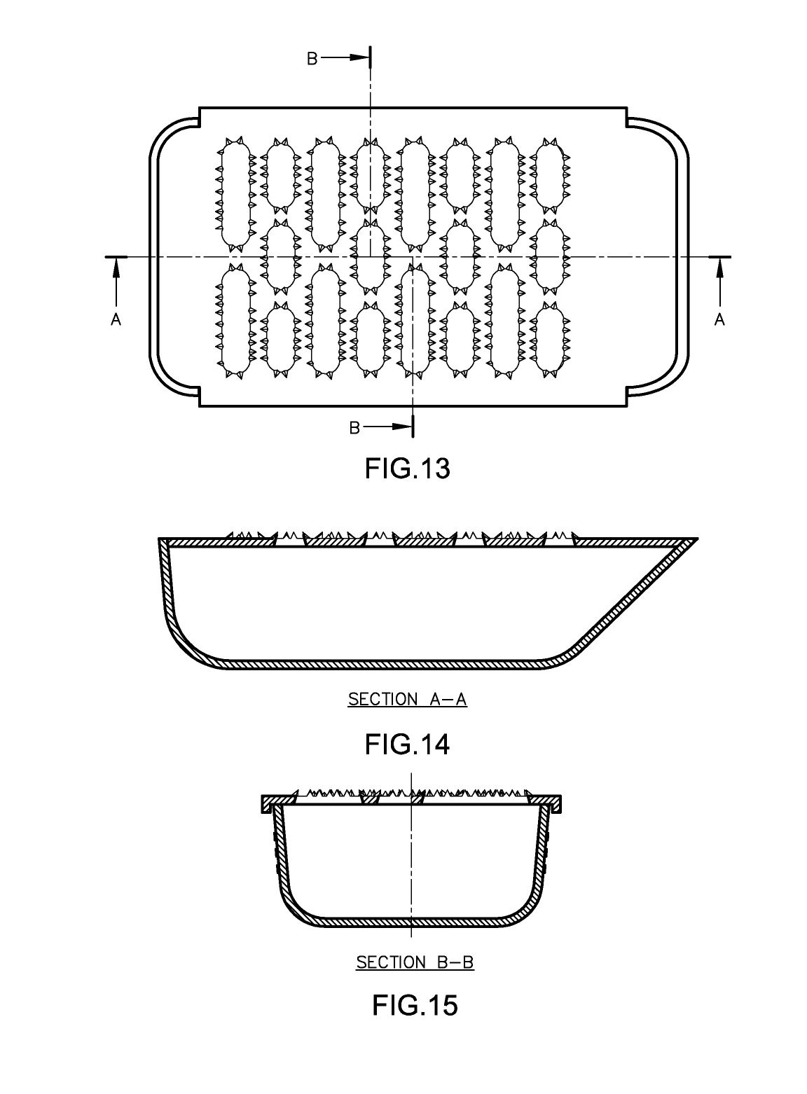

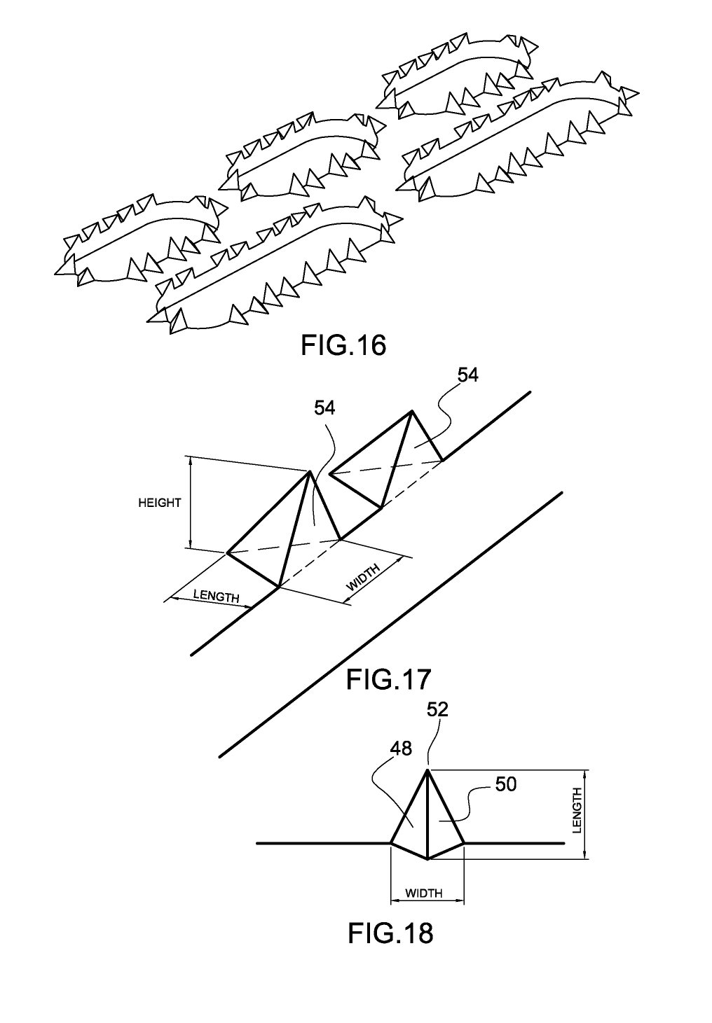

FIGS. 9-18 illustrate a second embodiment of a grating apparatus 42 according to the present invention. The grating apparatus 42 similarly has a grating member 44 but with fewer assemblies of pointed teeth. The grating member 42 also has a receptacle 46 although the bottom wall and a side wall of the receptacle is configured to facilitate slidably exit of grated foodstuff generated at grating surface and collected in the receptacle.

The body of the pointed teeth in this embodiment is substantially made of an injection moldable plastic(s) material. One main requirement of the plastic(s) material is that the material be relatively rigid physically and food safe.

As shown in FIG. 18, each pointed tooth has a pyramidal body defining at least a first triangular side 48 and a second triangular side 50 which share a common vertex 52. The surface of the first triangular side 48 or the second triangular 50 is inclined with respect to the grating surface of the grating member 44. Studies have shown that a grating apparatus with the pointed teeth of the grating member specifically configured and sized can achieve the object of the present invention. In this embodiment, depending on the particular tooth the first or second triangular side 48, 50 has an angle of inclination from 44-67° with respect to the grating surface. An angle of inclination refers generally to the angle between a slope and an x-axis. In the present context, the slope is the triangular surface and the x-axis is the grating surface.

As shown in FIG. 17, the pointed tooth body defines a third triangular side 54 which is substantially vertically disposed or perpendicular to the grating surface, and the third triangular side 54 share the same vertex 52 with the first and second triangular sides 48, 50.

It is to be understood that the pointed teeth at each assembly of teeth are not evenly distributed around the predetermined boundary. Although the teeth in each assembly are different in size, in this embodiment they range from preferably 0.93-1.53 mm in height, 1.50-1.59 mm in width, and 1.75-1.91 mm in length. Studies however have shown that the size of the teeth falling within the ranges of substantially 0.83-1.68 mm in height, 1.35-1.74 mm in width, and 1.57-2.10 mm in length can still produce satisfactory result.

The spacing of adjacent pointed teeth in an assembly of teeth also contributes to the grating performance. The spacing of a pair of adjacent pointed teeth is defined by the distance between the vertexes of the adjacent pointed teeth. In this embodiment, the spacing ranges from preferably 1.70-7.70 mm although the wider range of substantially 1.53-8.47 mm can still produce satisfactory result. In other words, varying or non-homogenous spacing among adjacent tooth pairs can contribute to an improved grating performance in the context of this invention.

It should be understood that certain features of the invention, which are, for clarity, described in the content of separate embodiments, may be provided in combination in a single embodiment. Conversely, various features of the invention which are, for brevity, described in the content of a single embodiment, may be provided separately or in any appropriate sub-combinations. It is to be noted that certain features of the embodiments are illustrated by way of non-limiting examples. Also, a skilled person in the art will be aware of the prior art which is not explained in the above for brevity purpose.

1. A grating apparatus comprising a grating member provided with a grating surface configured to interact with a food item, said grating member including a plurality of assemblies of teeth pointing away from the grating surface; wherein:
a) said assemblies of teeth include pointed teeth;
b) at least some of said pointed teeth have a vertex and a body defining at least a first triangular surface with an angle of inclination from substantially 44-67° with respect to the grating surface;
c) said grating member is substantially made of an injection moldable plastic(s), and wherein said body is pyramidal in shape and defines a second triangular surface generally symmetric to the first triangular surface;
d) said pyramidal bodies are non-homogenous in size;
e) said pyramidal body defines a third triangular surface, the third triangular surface is generally perpendicularly extended from the grating surface; and
f) said pyramidal body is made of relatively hard injection moldable plastic(s) for food grinding.

2. A grating apparatus as claimed in claim 1, wherein said pointed teeth have a height of substantially 0.83-1.68 mm or preferably 0.93-1.53 mm.

3. A grating apparatus as claimed in claim 1, wherein said pointed teeth have a width of substantially 1.35-1.74 mm or preferably 1.50-1.59 mm.

4. A grating apparatus as claimed in claim 1, wherein said pointed teeth have a length of substantially 1.57-2.1 mm or preferably 1.75-1.91 mm.

5. A grating apparatus as claimed in claim 1, wherein the density of said pointed teeth on the grating surface is 3-5 pointed teeth/cm², or preferably 4 pointed teeth/cm².

6. A grating apparatus as claimed in claim 1, wherein each of said assemblies of pointed teeth is arranged around a predetermined boundary, the predetermined boundary is generally in the shape of a rectangle, a circle, an oval or the English letter “L”.

7. A grating surface as claimed in claim 6, wherein said grating member is provided with cut-out regions at the predetermined boundary whereby in use grated foodstuff can pass through the cut-out regions.

8. A grating surface as claimed in claim 7, further comprising a container for containing grated foodstuff and on which said grating member can fit.

9. A grating surface as claimed in claim 8, wherein said container is sized and shaped to fit the grip of one palm of a user during a grating exercise such that in use the user can tightly hold on to said grater by the palm and grate a food item against said grating member with the other palm.

10. A grating apparatus as claimed in claim 1, wherein each said pointed tooth generally defines a vertical axis running through the vertex of said pointed tooth, and wherein the distance between vertexes of a pair of adjacent said pointed teeth is substantially 1.53-8.47 mm or preferably 1.70-7.70 mm.

11. A grating apparatus as claimed in claim 1, wherein said pointed teeth has a height, width and length of substantially 0.83-1.68 mm, 1.35-1.74 mm and 1.57-2.1 mm, respectively, and wherein the density of said pointed teeth on the grating surface is 3-5 pointed teeth/cm².
